(19) United States
(12) Patent Application Publication
(10) Pub. No.: US 2019/0193052 A1
(43) Pub. Date: Jun. 27, 2019

(54) FLUID ETCHED FOAM

(71) Applicant: The Procter & Gamble Company, Cincinnati, OH (US)

(72) Inventor: Wade Monroe HUBBARD, JR., Wyoming, OH (US)

(21) Appl. No.: 16/022,942

(22) Filed: Jun. 29, 2018

Related U.S. Application Data
(60) Provisional application No. 62/610,322, filed on Dec. 26, 2017.

(51) Int. Cl. B01J 20/28

(52) U.S. Cl. CPC B01J 20/28045

(57) ABSTRACT

An absorbent foam having a first surface and a second surface is disclosed. The foam has one or more etched voids. The one or more etched voids have an irregular inner surface.

### FIELD OF THE INVENTION

The present invention relates to a method of etching an absorbent foam structure by using a fluid. The absorbent structure is useful in absorbent articles such as diapers, incontinent briefs, training pants, diaper holders and liners, sanitary hygiene garments, and the like.

### BACKGROUND OF THE INVENTION

One of the challenges in creating an absorbent core for an absorbent article is the placement of absorbent material in specific desired locations. In reference to foam cores, traditionally, foam is located throughout the core and then portions may be extracted using knife. However, the use of a knife or punching out material may be time consuming since each aperture or slot must be cut out. If one utilizes a mold of the pattern to be cut out and stamps the pattern, then changing the pattern becomes cumbersome since a new mold must be made each time.

As such, there exists a need to create a method to reduce or remove absorbent material selectively within an absorbent foam structure. Additionally, there exists a need to reduce or remove absorbent material selectively within an absorbent core and to be able to change the desired removal pattern with ease.

### SUMMARY OF THE INVENTION

An absorbent foam is disclosed. The absorbent foam has a first surface and a second surface. The foam has one or more etched voids, wherein the one or more etched voids comprise an irregular inner surface.

An absorbent foam is disclosed. The absorbent foam has a first surface and a second surface. The foam has one or more etched voids, wherein the one or more etched voids comprises a first surface diameter and a second surface diameter, wherein the first surface diameter is greater than the second surface diameter.

An absorbent foam is disclosed. The absorbent foam has a first surface and a second surface, wherein the foam comprises one or more etched voids, wherein the one or more etched voids comprise an irregular inner surface and wherein the one or more etched voids comprises a first surface diameter and a second surface diameter, wherein the first surface diameter is greater than the second surface diameter.

### BRIEF DESCRIPTION OF THE DRAWINGS

While the specification concludes with claims particularly pointing out and distinctly claiming the subject matter of the present invention, it is believed that the invention can be more readily understood from the following description taken in connection with the accompanying drawings, in which:

FIG. 1 is a schematic view of a fluid etching process.

FIG. 2 is a top view of a fluid etched foam.

FIG. 3 is a bottom view of a fluid etched foam.

FIG. 4 is a magnified view of a portion of FIG. 2.

FIG. 5 is a magnified view of a portion of FIG. 3.

FIG. 6 is a cross section view of the foam of FIGS. 2 and 3.

FIG. 7 is a magnified view of FIG. 6.

FIG. 8 is a plan view of an absorbent article.

FIG. 9 is a top view of a fluid etched foam.

FIG. 10 is a bottom view of a fluid etched foam.

FIG. 11 is an SEM image of a magnified portion of FIG. 9

FIG. 12 is a top view of a fluid etched foam.

FIG. 13 is a bottom view of a fluid etched foam.

### DETAILED DESCRIPTION OF THE INVENTION

The present invention relates to a method for etching an absorbent foam structure using fluid. The fluid may be at a high pressure. High pressure as used herein relates to a pressure of sufficient capacity to expel fluid with enough force to impact and modify portions of the absorbent structure. High pressure as used herein relates to a pressure of sufficient capacity to expel fluid with enough force to impact and modify portions the open cell foam The foam structure may be an absorbent core or a portion of an absorbent core.

As used herein, the term “absorbent core structure” refers to an absorbent core that is has two or more absorbent core layers. Each absorbent core layer is capable acquiring and transporting or retaining fluid.

As used herein, “complex liquids” are defined as fluids that are non-Newtonian, whose rheological properties are complex that change with shear and commonly shear thin. Such liquids commonly contain more than one phase (red blood cells plus vaginal mucous) that may phase separate on contact with topsheets and absorbent materials. In addition, complex liquids such as menstrual fluid may contain long chain proteins exhibiting stringy properties, high cohesive force within a droplet allowing for droplet elongation without breaking. Complex liquids may have solids (menstrual and runny feces).

The term “disposable” is used herein to describe articles, which are not intended to be laundered or otherwise restored or reused as an article (i.e. they are intended to be discarded after a single use and possibly to be recycled, composted or otherwise disposed of in an environmentally compatible manner). The absorbent article comprising an absorbent structure according to the present invention can be for example a sanitary napkin or a panty liner or an adult incontinence article or a baby diaper or a wound dressing. The absorbent structure of the present invention will be herein described in the context of a typical absorbent article, such as, for example, a sanitary napkin. Typically, such articles can comprise a liquid pervious topsheet, a backsheet and an absorbent core intermediate the topsheet and the backsheet.

While particular embodiments of the present invention have been illustrated and described, it would be obvious to those skilled in the art that various other changes and modifications can be made without departing from the spirit and scope of the invention.

### General Summary

A method of etching an absorbent foam structure is disclosed.

In the following description of the invention, the surface of the article, or of each component thereof, which in use faces in the direction of the wearer is called wearer-facing surface. Conversely, the surface facing in use in the direction of the garment is called garment-facing surface. The absorbent article of the present invention, as well as any element thereof, such as, for example the absorbent core, has therefore a wearer-facing surface and a garment-facing surface.

The open-celled foam is a thermoset polymeric foam made from the polymerization of a High Internal Phase Emulsion (HIPE), also referred to as a polyHIPE. To form a HIPE, an aqueous phase and an oil phase are combined in a ratio between about 8:1 and 140:1. In certain embodiments, the aqueous phase to oil phase ratio is between about 10:1 and about 75:1, and in certain other embodiments the aqueous phase to oil phase ratio is between about 13:1 and about 65:1. This is termed the “water-to-oil” or W:O ratio and can be used to determine the density of the resulting polyHIPE foam. As discussed, the oil phase may contain one or more of monomers, co-monomers, photo-initiators, cross-linkers, and emulsifiers, as well as optional components. The water phase will contain water and in certain embodiments one or more components such as electrolyte, initiator, or optional components.

The open-cell foam can be formed from the combined aqueous and oil phases by subjecting these combined phases to shear agitation in a mixing chamber or mixing zone. The combined aqueous and oil phases are subjected to shear agitation to produce a stable HIPE having aqueous droplets of the desired size. An initiator may be present in the aqueous phase, or an initiator may be introduced during the foam making process, and in certain embodiments, after the HIPE has been formed. The emulsion making process produces a HIPE where the aqueous phase droplets are dispersed to such an extent that the resulting HIPE foam will have the desired structural characteristics. Emulsification of the aqueous and oil phase combination in the mixing zone may involve the use of a mixing or agitation device such as an impeller, by passing the combined aqueous and oil phases through a series of static mixers at a rate necessary to impart the requisite shear, or combinations of both. Once formed, the HIPE can then be withdrawn or pumped from the mixing zone. One method for forming HIPEs using a continuous process is described in U.S. Pat. No. 5,149,720 (DesMarais et al), issued Sep. 22, 1992; U.S. Pat. No. 5,827,909 (DesMarais) issued Oct. 27, 1998; and U.S. Pat. No. 6,369,121 (Catalfamo et al.) issued Apr. 9, 2002.

The foam may be fluid etched once the emulsion reaches a gel point. The foam may be fluid etched once the emulsion has polymerized into a foam. The foam may be fluid etched at any point between gel point polymerization and 100% polymerization. As used herein gel point relates to the point at which the emulsion has shifted from a liquid phase to a more solid like phase.

The fluid etching system may be located at any location in the process after the gel point such as, for example, prior to exiting the curing oven, after the curing oven, prior to dewatering the foam, after dewatering the foam, between a first curing oven and a second curing oven. In an embodiment, the first curing oven may allow for etching of the material within the oven prior to exposing the material to additional heat in the oven. The fluid etching may occur when the foam is fully expanded or after the foam has been compressed due to dewatering.

The fluid etching system may have one or more etching jets, such as, for example, less than 100 jets, between 1 and 100 jets, between 1 and 50 jets, between 5 and 25 jets, and between 10 and 20 jets.

In an embodiment, the fluid etching tool comprises of a line of fluid expelling jets that run along the transverse length of the core. The absorbent core passes under the etching jets. The etching jets are controlled to expel fluid at set velocities and pressures. The velocities may be varied as the absorbent core passes under the web. The etching jets may be programed to create a pattern on the absorbent core. For example, as a portion of the absorbent core passes under the etching jets, different jets may expel no fluid while other etching jets expel fluid at different velocities. Alternatively, the etching jets may move as the core passes under the fluid etching jets. For example, one or more jets may be connected such that the jets move back and forth along the width of the core to create a wave pattern. Additionally, one or more jets may be located to a single wheel that spins as the core moves under the fluid etching jets. Additionally, one or more fluid etching jets may be on an arm capable of etching out any desirable pattern. As the absorbent core continues to pass under the etching jets, the etching jets may vary in velocity and amount of fluid being expelled to create a predetermined pattern onto the absorbent core. Additionally, the spacing between etching jets may be variable to create different patterns.

In a further embodiment, the fluid etching jets can be contained in a fluid etching head that runs along the transverse length of the core. The number of fluid etching jets contained within a fluid etching head can vary depending on the width of the core passing underneath the fluid etching head such that the number of jets per inch are capable of delivering the desired pattern onto the absorbent core. For example, if the width is one foot and the desire is to have five jets per inch, then the fluid etching head may contain 60 fluid etching jets.

In an embodiment, the fluid etching system comprises of a line of fluid expelling jets that run along the transverse length of the core and the stencil comprising one or more patterns. The stencil, when utilized, may be located between the etching jets and the absorbent core when the absorbent core passes under the etching jets.

The fluid etching may be done with or without a stencil. Additionally, the fluid etching may be done in a two stage process wherein the first or second stage does not utilize a stencil and the other stage uses a stencil. The stencil may be in the form of a fixed stencil, a drum comprising a stencil, a cylinder having a stencil, a belt with apertures serving as the stencil, or a combination thereof. The stencil may have one continuous pattern, may have a walking pattern that is not set to a product pitch length, or may have a pattern that is set to a product pitch. The stencil may have more than one pattern wherein each pattern represents one of a walking pattern that is not equivalent to a product pitch or a pattern that is equivalent to a product pitch. The stencil pattern may be made of apertures in a repeating pattern. The stencil apertures may be in a random pattern. The stencil pattern may create, without limitation, a simple repeating pattern, non-repeating patterns, one or more words in any form of script used by any language, such as, for example, Mandarin characters, the Roman alphabet, the Greek alphabet, Japanese characters and in any font inclusive of cursive, or any other pattern imaginable inclusive of flowers, hearts, animals, images of abstract items. It is understood that the stencil pattern may be of any pattern that may be made using a stencil. The pattern may be different for along the width of the material being etched. For example, a first pattern may be located along 50% of the width of the material being etched and second pattern may be located along the other 50% of the width of the material being etched.

The stencils may repeat along the belt or may not. The stencil may be continuously repeating on a drum, belt, or any other rotating form. The drum or belt may have all unique stencils or repeat the same stencil. The stencil may be interchanged to add different patterns. For example, in the context of a drum or belt, different aspects of the belt or drum may be removed while leaving others such that one may change the stencils. The belt may be continuous, with bearings on both sides, cantilevered, or having a seam.

The belt may comprise of any material capable of surviving the chosen conditions in the process. The belt may be made of metal, one or more polymers, or combinations thereof. The belt may be porous or non-porous.

Examples of belts may include endless belts made of one or more metals, a resin, or combinations thereof; or sheet materials such as films that may be positioned on the belt and moving therewith.

The belt may be of any dimension or configuration provided that it is parallel to the foam when under the fluid etching jet.

The stencil may be made of any material capable of surviving the chosen conditions in the process. The stencil may be made of metal, one or more polymers, or combinations thereof.

A rotating stencil in the form of a drum or belt may be driven by its own motor or may be driven by an idler roller. The stencil may contact the absorbent core prior at a given point and be driven by the absorbent core roller. Additionally, both the absorbent core belt and the stencil may be driven by their own independent motors.

The stencil is located between the etching jets and the absorbent core. The stencil allows for fluid exiting the etching jets to contact the material being etched. If the stencil is a hollow cylinder, then the cylinder pattern comprises of one or more apertures in the cylinder that allows fluid to pass through the cylinder. The apertures may be in the form of any visual pattern imaginable. Upon exiting the cylinder, the fluid allowed to pass through the stencil contacts the absorbent core thereby replicating the cylinder pattern onto the absorbent core. The cylinder may have one repeating pattern or a plurality of patterns. Each pattern may be equivalent to the length of one absorbent core in the machine direction.

The fluid etching process may utilize more than one stage wherein a first stage has a first set of one or more etching jets and a second stage has a second set of one or more etching jets. Each of the first stage and the second stage may or may not have a stencil. The two stage approach may be utilized to create both voids and fissures. For example, the voids may be created at the first stage having a first pattern while the fissures may be created at the second stage having a second pattern; the resultant etched material having a pattern that is visible from above and additionally a pattern along the vertical Z direction that may be exhibited in a cross section of the etched material. It is understood that more than two stations may be used and/or that a stage may contain more than one etching jet, more than one fluid, and more than one stencil.

The fluid may consist of at least 50% dihydrogen oxide, such as, for example, 60% dihydrogen oxide, 70% dihydrogen oxide, 80% dihydrogen oxide, 90% dihydrogen oxide, 100% dihydrogen oxide, such as, for example, between 80% and 100% dihydrogen oxide. The fluid may contain other items such as, for example, process modifiers, salts used in the process, surfactants, perfume, modifiers enabled to change the hydrophilic/hydrophobic balance of the stratum of heterogeneous layer, any additive to change the structure of the open cell foam, or combinations thereof. The fluid may contain a particulate such as, silica, metal particles, polymers, or combinations thereof. The fluid may contain one or more process modifiers capable of affecting the properties of the fibrous layer, such as, for example, adding citric acid to the fluid to further crosslink a nonwoven web. Additionally, the fluid may be used to modify the pH of the absorbent stratum.

The carrier belt carries the absorbent structure through the fluid etching process. The carrier belt can be any thickness or shape suitable. Further, the surface of the belt can be substantially smooth or may comprise depressions, protuberances, or combinations thereof. The pattern on the belt may be designed to work with the stencil pattern such that the two patterns are coordinated to create a predetermined pattern. The protuberances or depressions may be arranged in any formation or order to create the pattern in the carrier belt. The belt may comprise one or more materials suitable for the polymerization conditions (various properties such as heat resistance, weatherability, surface energy, abrasion resistance, recycling property, tensile strength and other mechanical strengths) and may comprise at least one material from the group including films, non-woven materials, woven materials, and combinations thereof. Examples of films include, fluorine resins such as polytetrafluoroethylene, tetrafluoroethylene-perfluoroalkylvinyl ether copolymers, tetrafluoroethylene-hexafluoropropylene copolymers, and tetrafluoroethylene-ethylene copolymers; silicone resins such as dimethyl polysiloxane and dimethylsiloxane-diphenyl siloxane copolymers; heat-resistant resins such as polyimides, polyphenylene sulfides, polysulfones, polyether sulfones, polyether imides, polyether ether ketones, and para type aramid resins; thermoplastic polyester resins such as polyethylene terephthalates, polybutylene terephthalates, polyethylene naphthalates, polybutylene naphthalates, and polycyclohexane terephthalates, thermoplastic polyester type elastomer resins such as block copolymers (polyether type) formed of PBT and polytetramethylene oxide glycol and block copolymers (polyester type) formed of PBT and polycaprolactone may be used. These materials may be used either singly or in mixed form of two or more materials. Further, the belt may be a laminate comprising two or more different materials or two or more materials of the same composition, but which differ in one or more physical characteristics, such as quality or thickness.

The fluid etching system may be designed to add between 0.2 to 50 kilowatt hour/kilogram to the absorbent structure, such as for example, between 0.5 to 40 kilowatt hour/kilogram, between 1 to 30 kilowatt hour/kilogram, or between 5 to 20 kilowatt hour/kilogram. One of ordinary skill in the art would understand that the amount of energy inserted into an absorbent structure such as, for example, an absorbent stratum, by the etching system is based on the jet diameters of the individual jets and the pressure at which the jets are ran. As such, more than one configuration may be used to achieve the desired energy insertion level.

The fluid etching system may run at a pressure between 20 and 400 bar, such as, for example, between 20 and 350 bar, 30 and 320 bar, 40 and 300 bar, 50 and 250 bar, 60 and 200 bar, 70 and 150 bar, 80 and 100 bar. The fluid etching system may run at a pressure between 20 and 100 bar.

The fluid jet diameter may be between 20- 400 microns, such as for example, between 30 and 300 microns, between 40 and 250 microns, between 50 and 200 microns, between 75 and 150 microns, and between 100 and 125 microns. The fluid jet diameter may be variable throughout or fixed.

The etching system may input energy into a foam layer or into an absorbent core or into an absorbent stratum. The total amount of energy input into a system may be based upon the fluid pressure and the number of etching jets. The energy may be calculated according to the following equation:

$$Specific Energy = 2.622 * \frac{{10}^{3} ( ( {Cd}_{1}^{2} {P}_{g}^{\frac{3}{2}} ) * N * Passes )}{WS} ( \frac{kJ}{kg} )$$

Where:

C=coefficient of discharge, dimensionless

d₁=inlet diameter, mm

P_{g}=gauge pressure, bar

N=number of jets per inch of manifold

Passes=number of passes acted on etched layer

W=basis weight, g/m²

S=line speed, m/min

The fluid etch system may be designed to remove or displace foam from a heterogeneous mass layer. The fluid etching system may be designed to create a three dimensional pattern within the foam layer having one of fissures alone, voids alone, or a combination of both fissures and voids.

Without being bound by theory, removal, displacement, or destruction of the foam, during the etching process can be explained partially by cavitation. When a liquid jet (for this example, a cross-section of a column of liquid) reaches or enters the foam, the liquid encounters a certain number of cells within the foam. As the jet liquid enters these cells of the foam it then moves between adjacent and lower cells through the smaller, intercellular opening or windows. The initial velocity of the jet may thereby be subdivided between the number of cells that is covered by the cross-sectional area of the liquid jet, and, then be further subdivided by the number of windows within these affected cells. On each side of these windows is an open cell of a larger size than the window the liquid is passing through to get to it. This sudden change in opening size, or orifice, may result in a sudden change in fluid pressure. This sudden change in fluid pressure, from high to low, may result in cavitation.

For example, if the open-celled foam has cells of 50 micron diameter, it may have windows of 1.7 micron diameter and there may be up to 20 windows in that cell that lead to the next cell of 50 micron diameter. By knowing the fluid jet's velocity and cross-sectional diameter, the number of cells impinged can be calculated, and therefore, the number of windows to flow though. For this instance, a 2.8×10-8 m³/sec fluid jet's volumetric flowrate can impinge 565 windows of 1.7 micron diameter such that the individual window velocity is 22 msec. If the fluid is dihydrogen oxide, then one can enter these values into the Cavitation Equation (K). Since the foam is open-celled and at room temperature and pressure, the static pressure just downstream of the window or orifice is 101325 Pa. The density of dihydrogen oxide is 1000 kg/m³ and its vapor pressure is 3167 Pa. The mean velocity through the window or orifice hole is 22 msec. The resultant Cavitation Number (K) is 0.4 and those skilled in the art know that this indicates cavitation since K is less than 1. If K is greater than 1, then cavitation isn't occurring. As the fluid passes through more and more cells and windows, cavitation will cease once the velocity gets low enough to bring the Cavitation Number above 1. Therefore, if one knows the cell size, number of cells per area, the window size, and the number of windows in the cells, one skilled in the art can design the water jet such that it imparts just the right volumetric flow rate, over a desired cross-sectional area, to impart just the right level of cavitation so that the depth and extent of removal can be obtained.

$$K = \frac{{P}_{dl} - {P}_{v}}{\frac{1}{2} * ρ * {v}_{0}^{2}}$$

Wherein K is the cavitation number; P_{d1} is the static pressure just at downstream of the orifice (Pa); Pᵥ is the vapor pressure of fluid (Pa); ρ is the density of fluid (kg/m³); and v₀ is the mean velocity through the orifice hole (m/s).

After polymerization, the absorbent structure may go through a fluid etching process. The fluid etching process utilizes one or more fluids to modify portions of the absorbent structure by impacting the open celled foam and/or the enrobeable elements. The fluid etching process includes exposing at least a portion of the absorbent structure to one or more jets capable of expelling fluid at a desired velocity driven by the pressure in the fluid expelling jets. The absorbent structure may be an absorbent stratum, an absorbent core, or a portion of an absorbent core. The absorbent structure, may or may not comprise the topsheet or a secondary topsheet.

The fluid etching process may be coordinated with the carrier belt. The etching jets may oscillate to create a wave pattern on the absorbent core.

In an embodiment, the polymerized absorbent core is exposed to one or more etching jets that are attached to a carrier system. The carrier system is allowed to move over the web thereby allowing the individual jets to cover the entire top surface area of the absorbent core. The jets may be arranged in any geometric order such as in a square pattern, in a circular pattern, in a line pattern. The carrier system may move over the absorbent core within a predetermined space. The carrier system may have an arm with a pivot that moves the one or more etching jets over the predetermined space. The space may be the entire area of the absorbent core or a partial area of the absorbent core.

Applicants have surprisingly found that one may create a pattern of different depths within an absorbent foam core by using one or more fluid expelling jets. The fluid etching process may create fissures that do not cross through the absorbent foam or may create voids that may cross through the absorbent foam. When fissures are created, the fissures may be seen from the surface that was fluid etched and may not be seen from the surface that was not etched. The fissures may penetrate between 1% and 99% of the foam absorbent layer, such as, for example, between 5% and 90%, between 10% and 80%, between 15% and 70%, between 20% and 60%, between 25% and 50%. When the fluid etching process creates voids, the voids may be seen from the first surface and from the second surface.

Without being bound by theory, it has been found that the addition of fissures and voids to the absorbent structure serves to increase the surface area within the absorbent structure and allows for the fissures and voids to create points of bending in one of the machine direction, cross direction, or along the vertical plane, while allowing the absorbent structure having the fissures and voids to maintain a structural integrity substantially equal to the same absorbent structure without the fissures and voids.

Voids may comprise of different density portions of foam within the void when compared to the rest of the foam layer. The different density portions of foam may exhibit a higher density than the areas adjacent to the void within the layer.

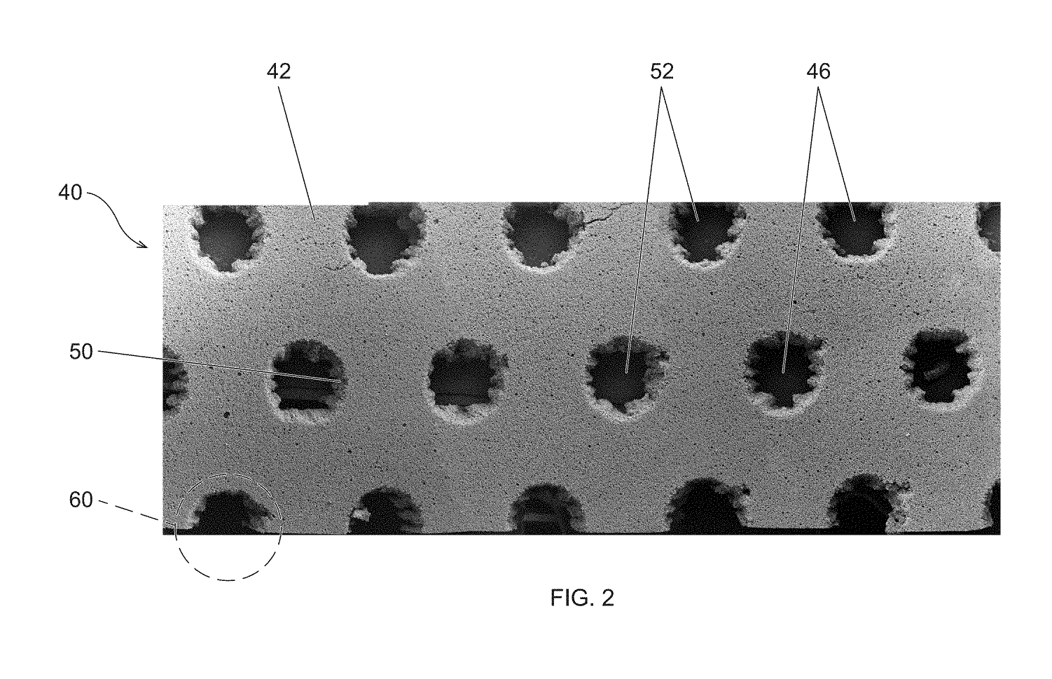

As shown in FIGS. 2-7, below, the velocity of the fluid and the duration of time the absorbent core is exposed to the fluid at a given velocity impacts the amount of energy placed into the absorbent core for a given area of the core thereby impacting the absorbent material in the core. As such, one may vary the depth of impact to the absorbent core at a given point along the vertical direction based upon the amount of energy input into the absorbent core. As a result, the absorbent foam is selectively fractured in comparison to the adjacent foam that is undisturbed.

Fluid etching jets are utilized in the present invention to modify as-made absorbent materials into absorbent materials having relatively higher permeability and increased surface area without a significant corresponding decrease in capillary pressure and without a significant corresponding decrease in structural integrity for the absorbent structure. Additionally, the use of fluid etching surprisingly allows one to modify the open cell foam at the micro level. For example, using fluid etching, one may modify the foam between two fibers without impacting the fibers. Depending on the setting used during fluid etching, it has been found that the process described above allows for the creation of shapes that cannot be accomplished by using a mechanical removal/displacement process. Essentially, using fluid etching allows for one to modify one or more pieces of absorbent foam at a micro level versus a macro level.

It has also been surprisingly found that by modifying or removing one or more open cell foam pieces, one may modify fluid handling properties, mechanical properties including but not limited to stiffness.

Furthermore, the modified absorbent layers exhibit improved fluid acquisition properties and improved structural properties.

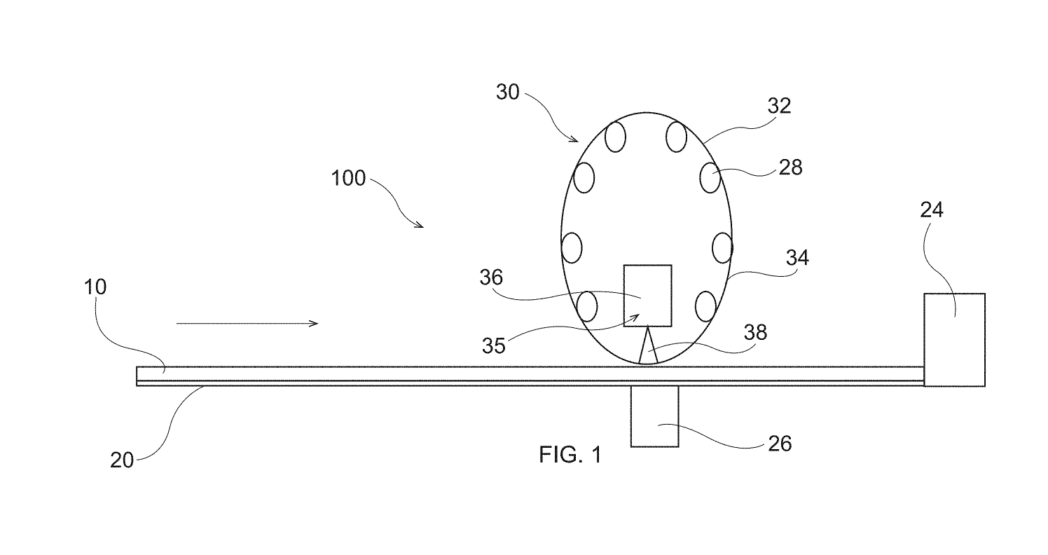

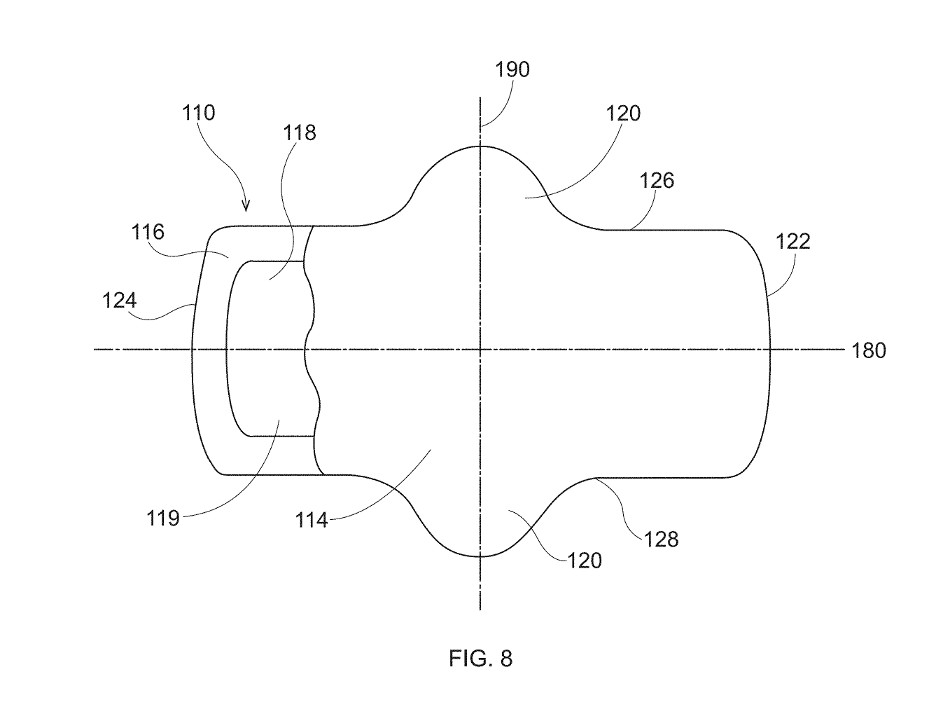

FIG. 1 shows a schematic of the method 100 disclosed in the specification. As shown in the figure the absorbent structure 10 is placed on a carrier belt 20. The carrier belt 20 carries the absorbent structure 10 under a fluid etching system 30. The fluid etching system 30 may include a stencil 32 which may be a pattern belt 34 ran by rollers 28, and one or more fluid jets 36. When the absorbent structure 10 passes under the fluid etching system 30, the fluid 38 contacts the stencil 32 and impacts the absorbent structure 10 where open spaces exist in the stencil 32. Dependent upon the settings of the process, the fluid 38 may either form fissures 42 (not shown) in the absorbent structure 10 or voids 44 (not shown) in the absorbent structure 10. As is to be appreciated, the patterned absorbent structure produced by the process of FIG. 1 may be used in the manufacturing of a variety of absorbent articles, such as the sanitary napkin 110 of FIG. 8, as well as a variety of other absorbent articles, including diapers, training pants, adult incontinence undergarments, and the like.

During the etching process, the absorbent structure 10 is passed by the jet head 35 that comprises a plurality of injectors that are positioned to generally form a water curtain (for simplicity of illustration, only one injector 36 is illustrated in FIG. 1). A water jet 38 is directed into the stratum of heterogeneous mass 12 at high pressures, such as between 150 to 400 bar. As is to be appreciated, while not illustrated, one or more rows of injectors 36 may be used, which may be positioned on one or both sides of the stratum of absorbent structure 10.

The absorbent structure 10 may be supported by any suitable support system or carrier belt 20, such as a moving wire screen or on a rotating porous drum, for example. While not illustrated, it is to be appreciated that fluid etching systems may expose the stratum of heterogeneous mass 12 to a series of jet heads (not shown) along the machine direction, with each delivering water jets at different pressures. The particular number of jet heads utilized may be based on, for example, desired basis weight, amount of etching, characteristics of the web, and so forth. As the fluid from an etching jet 36 penetrates the web, a vacuum 26 having suction slots positioned proximate beneath the stratum of heterogeneous mass 12 collects the water so that it may be filtered and returned to the etching jet 36 for subsequent injection. The fluid 38 delivered by the etching jet 36 exhausts most of its kinetic energy primarily in etching the absorbent structure second layer 16 within a stratum of heterogeneous mass 12.

Any fluid used for etching may be collected by any means known in the art such as, for example, a vacuum box (shown in FIG. 1), gravity, nip rollers, or a combination thereof. The collected fluid may be recycled and reused in the system. Additionally, the collected fluid may be treated to remove any undesired carryover and to prevent microbial growth.

Once a stratum of foam 12 has been fluid etched, the fluid etched stratum of foam 12 is then passed through a dewatering device where excess water is removed. In the process illustrated in FIG. 1, the dewatering device is a drying unit 24. The drying unit 24 may be any suitable drying system, such as a multi-segment multi-level bed dryer, a vacuum system, and/or an air drum dryer, for example. The drying unit 24, or other dewatering device, serves to substantially dry the fluid etched stratum of foam 12 before subsequent heat treatment. The term “substantially dry” is used herein to mean that the fluid etched stratum of heterogeneous mass has a liquid content, typically water or other solution content, less than about 10%, less than about 5%, or less than about 3%, by weight.

Once the fluid etched stratum of foam is substantially dry, the fluid etched stratum of foam may be heated to an elevated temperature. By heating the fluid etched stratum of foam to a particular temperature, or temperature range, the flexural rigidity of the fluid etched stratum of foam may be increased (i.e., stiffened). Additionally, one may heat the fluid inserted into the stratum.

It has been surprisingly found that one may create voids in an open cell foam such as a High Internal Phase Emulsion foam that by using fluid etching. Specifically, it has been found that one can create voids that have a gradient diameter through the foam such that the diameter of the void in the first surface of the foam is larger than the diameter of the void in the second surface of the foam. By varying the conditions used during the etching process, such as pressure, and the stencil used to etch the foam, one can create different geometries within a void that without varying the first surface diameter. Additionally, one can increase the pressure or modify the stencil so that the void has a uniform diameter at both the first surface of the foam and the second surface of the foam.

Further, it has surprisingly been found that by fluid etching the foam material, one creates a foam that has an irregular or non-smooth inner surface. This creates additional surface area within the void that can contact fluid that enters the void. This is unlike a traditional machined perforation that leaves a smooth edge or a knife that would also leave a smooth edge. By creating an irregular surface versus a smooth straight edge, the surface area that will be in contact with fluid increases thereby increasing desireable properties such as, for example, the acquisition speed of the core, and additionally creates more pathways for the fluid to enter the foam material or core.

The described fluid etching process also has improvements regarding the handling of material which is removed from the void. Due to the use of fluid in the etching process, the etching process is placed prior to the drying stage. This represents that the removed material contains over 90% moisture thereby increasing the mass of the material being removed. Further, by removing pieces with moisture, one can reduce any potential static charges thereby making it easier to handle the pieces. This is unlike traditional stamping processes or knife cutting processes that remove dry material which is lightweight and may carry an electric charge, thereby causing handling issues. Because the fluid etching process relies upon the use of fluid jets and fluid, it also has the advantage of not wearing out tooling. Specifically, when one uses stamp tooling, the pieces may plug up the stamp tool over time and/or the tool will eventually wear down and need to be replaced. Further, if one desires to make changes to the design, one can simply modify the stencil versus having to replace expensive stamp tooling.

FIG. 1 shows a schematic of the method 100 disclosed in the specification. As shown in the figure the absorbent structure 10 is placed on a carrier belt 20. The carrier belt 20 carries the absorbent structure 10 under a fluid etching system 30. The fluid etching system 30 may include a stencil 32 which may be a pattern belt 34 ran by rollers 28, and one or more fluid jets 36. When the absorbent structure 10 passes under the fluid etching system 30, the fluid 38 passes through the stencil 32 and impacts the absorbent structure 10. Dependent upon the settings of the process, the fluid 38 may either form fissures 42 (not shown) in the absorbent structure 10 or voids 44 (not shown) in the absorbent structure 10.

As shown in FIGS. 2-7 and 9-12, the fluid etching process may create apertures or slots in the foam shown as voids. The apertures or slots may have irregular shapes. The etched foams of FIGS. 2-7 and 9-12 were made using two or more fluid jets. The first jet having pressure of 40 bar, the second jet having a pressure of 120 bar and a diameter of 120 micrometers (μm). The different patterns were created by using different stencils.

FIG. 2 is an SEM image of a first surface 42 of a foam 40 having etched voids 46 in the form of apertures 52. The apertures 52 have an irregular or non-smooth inner surface 50.

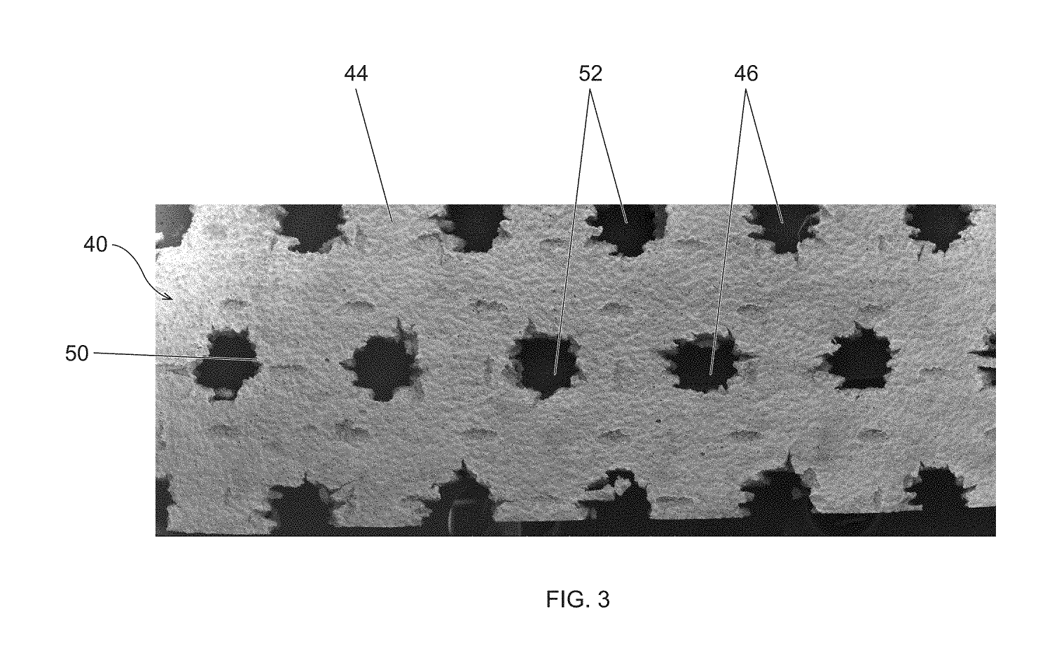

FIG. 3 is an SEM image of a second surface 44 of a foam 40 etched voids 46 in the form of apertures 52. The apertures have an irregular or non-smooth inner surface 50.

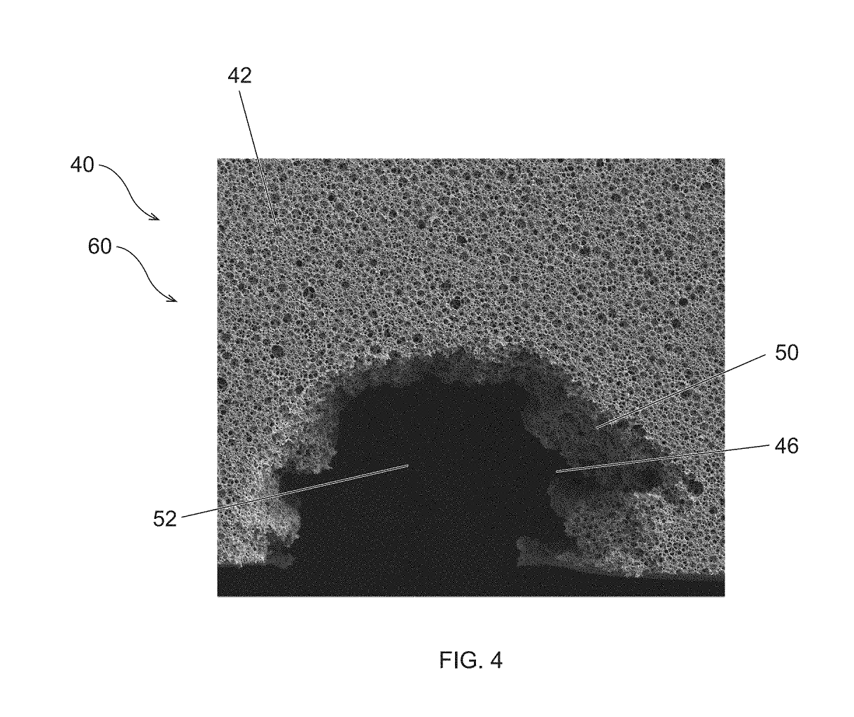

FIG. 4 is an SEM image of a magnified view 60 of an aperture of FIG. 2. As shown in FIG. 4, the foam 40 has a first surface 42 having an etched void 46 in the form of an aperture 52. The aperture has an irregular or non-smooth inner surface 50.

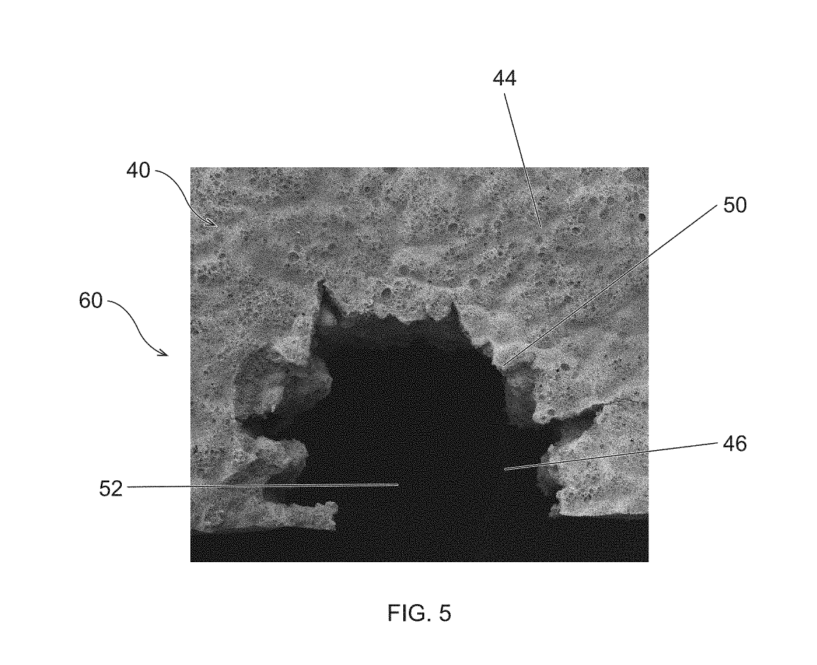

FIG. 5 is an SEM image of a magnified view 60 of an aperture of FIG. 3. As shown in FIG. 5, the foam 40 has a second surface 44 having an etched void 46 or void in the form of an aperture 52. The aperture has an irregular or non-smooth inner surface 50.

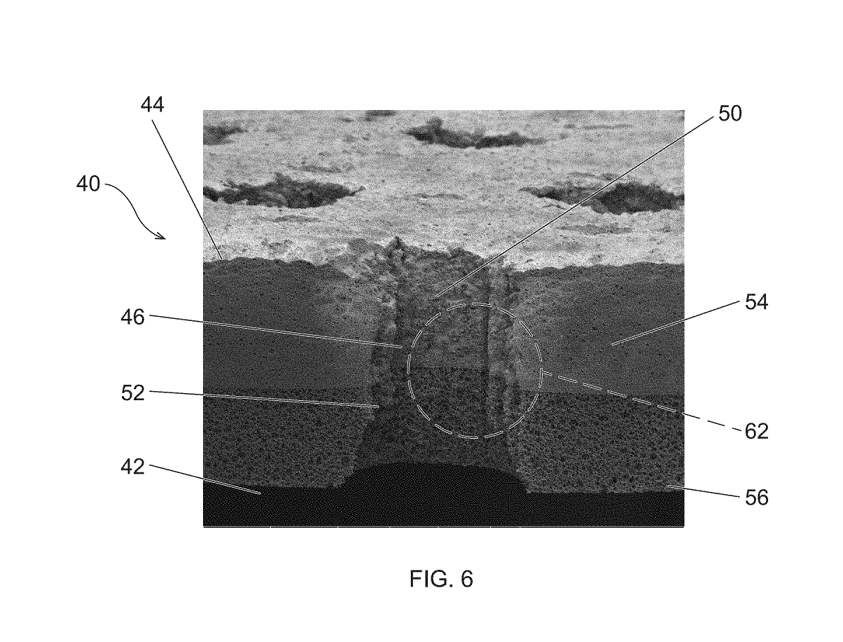

FIG. 6 is an SEM image of a cross section of the aperture of FIGS. 4 and 5. As shown in FIG. 6, the foam 40 has a first surface 42, a second surface 44, and an etched void 46 in the form of an aperture 52 having an irregular or non-smooth inner surface 50. As shown in FIG. 6, the diameter of the void at the first surface is greater than the diameter of the void at the second surface.

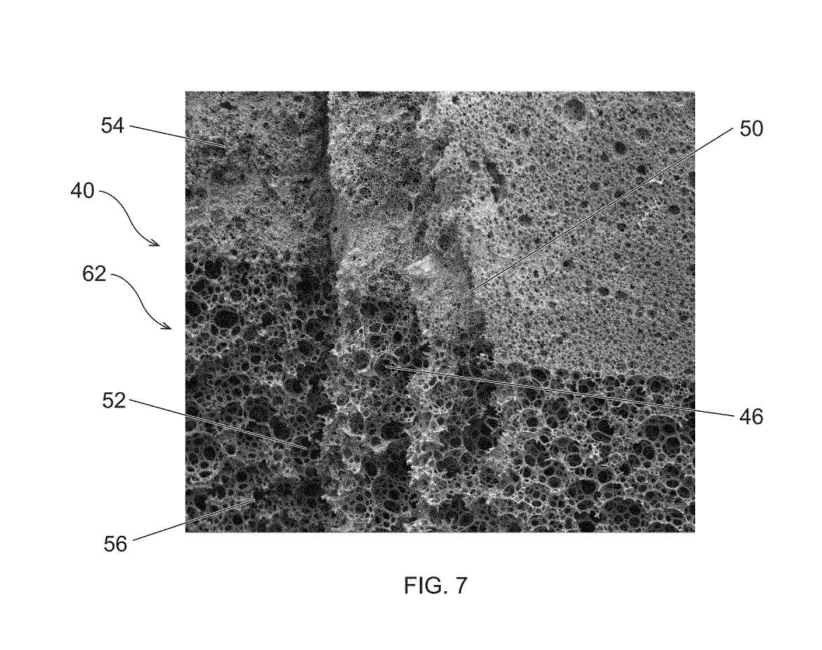

FIG. 7 is an SEM image of a magnified view 62 of a portion of FIG. 6. As shown in FIG. 7, the foam 40 has an aperture 46 having an irregular or non-smooth inner surface 50.

Referring to FIG. 8, an absorbent article of the present disclosure may be a sanitary napkin 110. The sanitary napkin 110 may comprise a liquid permeable topsheet 114, a liquid impermeable, or substantially liquid impermeable, backsheet 116, and an absorbent core 118. The liquid impermeable backsheet 116 may or may not be vapor permeable. The absorbent core 118 may have any or all of the features described herein with respect to the absorbent core 30 and, in some forms, may have a secondary topsheet 119 (STS) instead of the acquisition materials disclosed above. The STS 119 may comprise one or more channels, as described above (including the embossed version). In some forms, channels in the STS 119 may be aligned with channels in the absorbent core 118. The sanitary napkin 110 may also comprise wings 120 extending outwardly with respect to a longitudinal axis 180 of the sanitary napkin 110. The sanitary napkin 110 may also comprise a lateral axis 190. The wings 120 may be joined to the topsheet 114, the backsheet 116, and/or the absorbent core 118. The sanitary napkin 110 may also comprise a front edge 122, a back edge 124 longitudinally opposing the front edge 122, a first side edge 126, and a second side edge 128 longitudinally opposing the first side edge 126. The longitudinal axis 180 may extend from a midpoint of the front edge 122 to a midpoint of the back edge 124. The lateral axis 190 may extend from a midpoint of the first side edge 128 to a midpoint of the second side edge 128. The sanitary napkin 110 may also be provided with additional features commonly found in sanitary napkins as is known in the art.

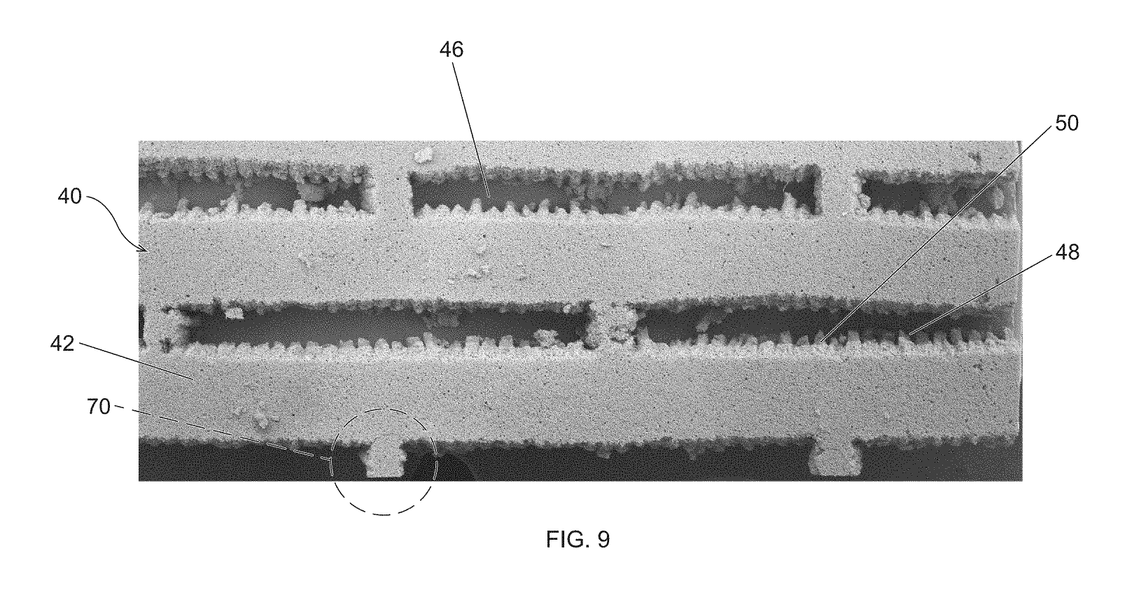

Fluid etching may be used to create apertures as shown in FIGS. 2-7 or slots as shown in FIGS. 9-12.

FIG. 9 is an SEM image of the first surface 42 of a foam 40. As shown in FIG. 9, the fluid etched foam 40 may have etched voids 46 in the form of slots 48.

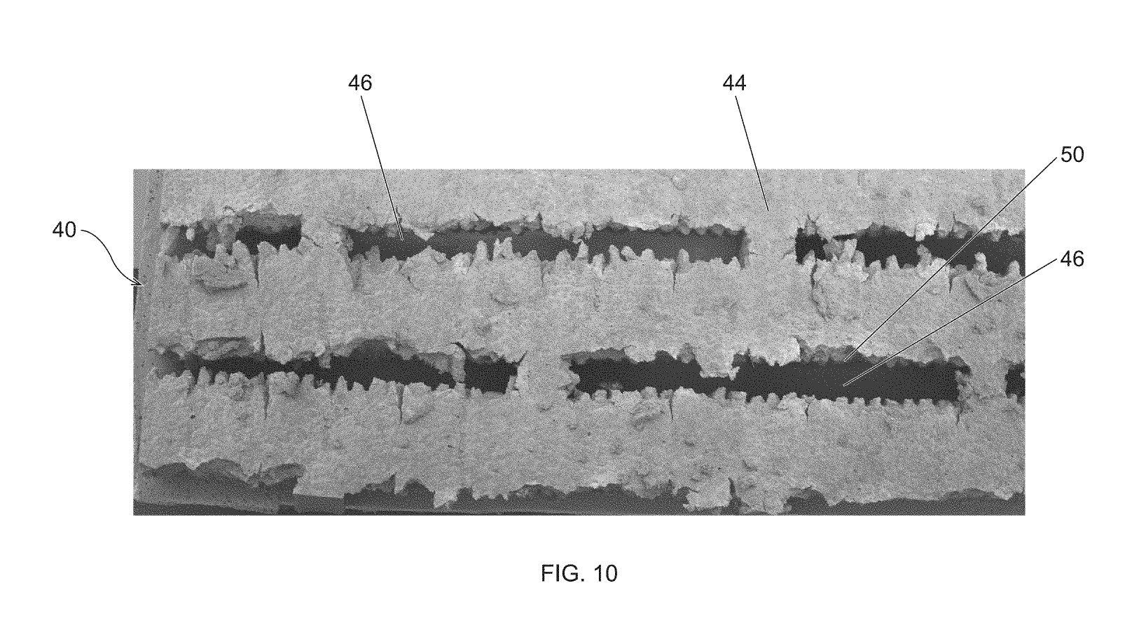

FIG. 10 is an SEM image of the second surface 44 of a foam 40. As shown in FIG. 10, the fluid etched foam 40 may have etched voids 46 in the form of slots 48.

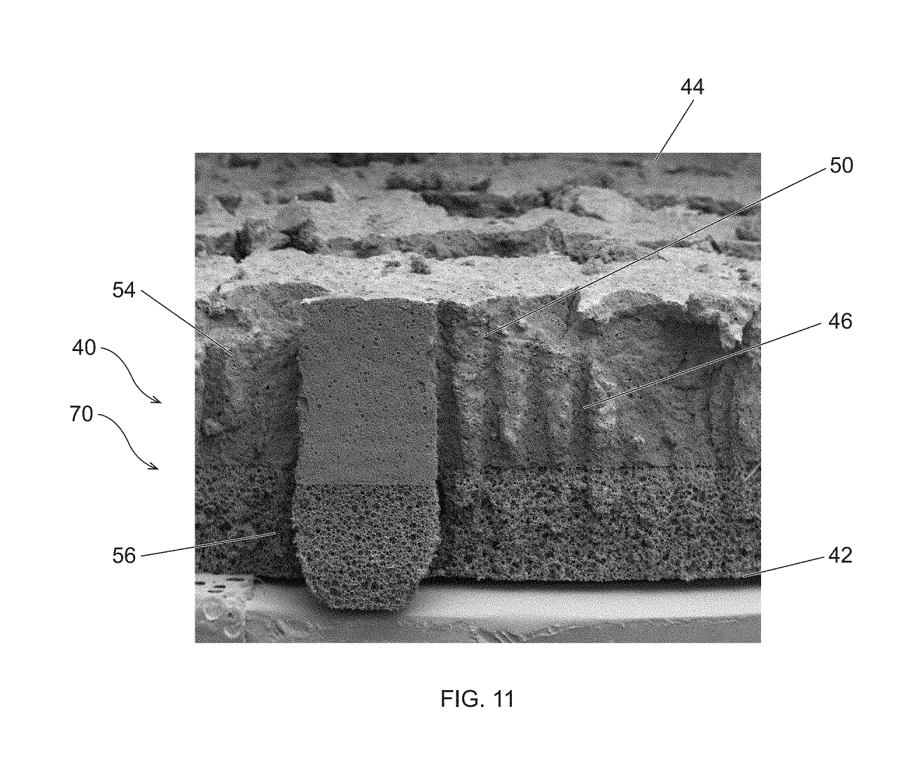

FIG. 11 is an SEM image of a magnified portion 70 of FIG. 9. As shown in FIG. 11, the foam has a first surface 42, a second surface 44, a first layer 54, a second layer 56. The foam has an etched void 46 having an irregular or non-smooth inner surface 50.

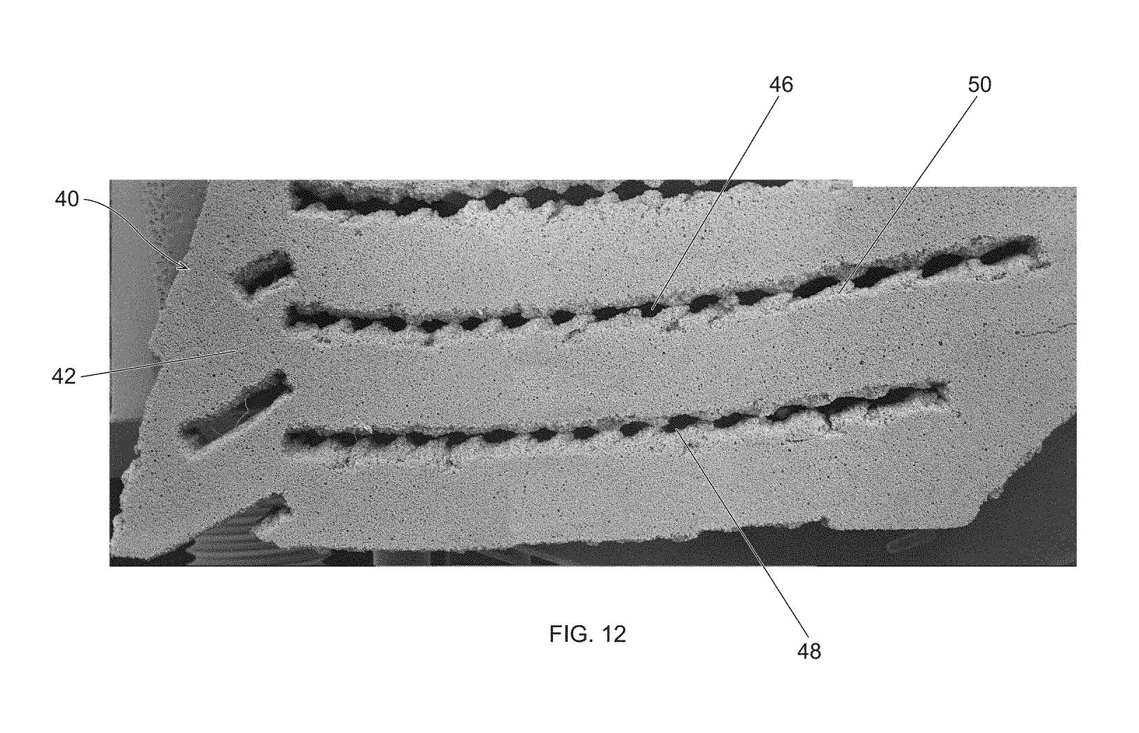

FIG. 12 is an SEM image of the first surface 42 of a foam 40. As shown in FIG. 11, the fluid etched foam 40 may have etched voids 46 in the form of slots 48.

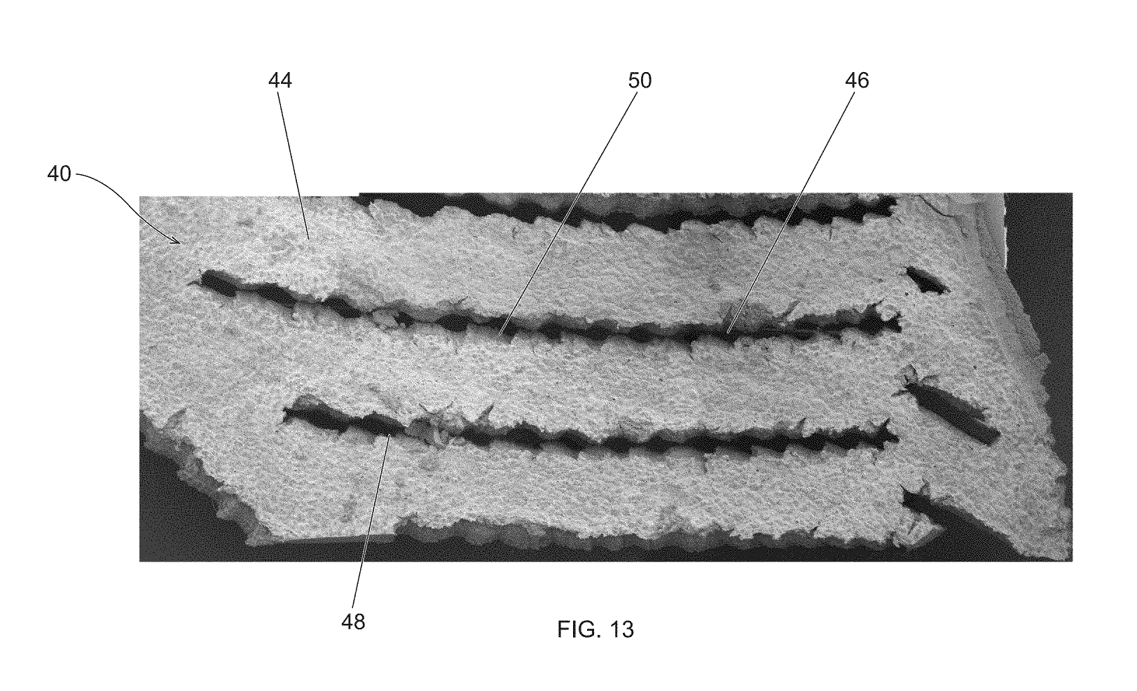

FIG. 13 is an SEM image of the second surface 44 of a foam 40. As shown in FIG. 12, the fluid etched foam 40 may have etched voids 46 in the form of slots 48.

With regard to the sanitary napkin 110 of FIG. 8, the secondary topsheet 20 incorporating the fluid etched stratum of heterogeneous mass may be bonded to, or otherwise attached to the topsheet 114. In some embodiments, thermal point calendaring or other suitable bonding is utilized. In other embodiments, the fluid etched stratum of heterogeneous mass may serve as an absorbent core of an absorbent article. The fluid etched stratum of heterogeneous mass may serve as the topsheet for an absorbent article, the secondary topsheet of an absorbent article. Additionally, an absorbent article may utilize two or more fluid etched stratums of heterogeneous masses within one absorbent article. For example, panty liners and incontinence pads may be formed with the fluid etched stratum of heterogeneous mass positioned between a topsheet and a bottom sheet to function as an absorbent core. Furthermore the fluid etched absorbent structure having a first layer and a second layer may not include a binder component.

The sanitary napkin 110 may have any shape known in the art for feminine hygiene articles, including the generally symmetric “hourglass” shape, as well as pear shapes, bicycle-seat shapes, trapezoidal shapes, wedge shapes or other shapes that have one end wider than the other.

The topsheet 114, the backsheet 116, and the absorbent core 118 may be assembled in a variety of well- known configurations, including so called “tube” products or side flap products, such as, for example, configurations are described generally in U.S. Pat. No. 4,950,264, “Thin, Flexible Sanitary Napkin” issued to Osborn on Aug. 21, 1990, U.S. Pat. No. 4,425,130, “Compound Sanitary Napkin” issued to DesMarais on Jan. 10, 1984; U.S. Pat. No. 4,321,924, “Bordered Disposable Absorbent Article” issued to Ahr on Mar. 30, 1982; U.S. Pat. No. 4,589,876, and “Shaped Sanitary Napkin With Flaps” issued to Van Tilburg on Aug. 18, 1987. Each of these patents is incorporated herein by reference.

Following polymerization, the resulting foam pieces are saturated with aqueous phase that needs to be removed to obtain substantially dry foam pieces. In certain embodiments, foam pieces may be squeezed free of most of the aqueous phase by using compression, for example by running the heterogeneous mass comprising the foam pieces through one or more pairs of nip rollers. The nip rollers may be positioned such that they squeeze the aqueous phase out of the foam pieces. The nip rollers may be porous and have a vacuum applied from the inside such that they assist in drawing aqueous phase out of the foam pieces. In certain embodiments, nip rollers may be positioned in pairs, such that a first nip roller is located above a liquid permeable belt, such as a belt having pores or composed of a mesh-like material and a second opposing nip roller facing the first nip roller and located below the liquid permeable belt. One of the pair, for example the first nip roller may be pressurized while the other, for example the second nip roller, may be evacuated, so as to both blow and draw the aqueous phase out the of the foam. The nip rollers may also be heated to assist in removing the aqueous phase. In certain embodiments, nip rollers are only applied to non-rigid foams, that is, foams whose walls would not be destroyed by compressing the foam pieces.

In certain embodiments, in place of or in combination with nip rollers, the aqueous phase may be removed by sending the foam pieces through a drying zone where it is heated, exposed to a vacuum, or a combination of heat and vacuum exposure. Heat may be applied, for example, by running the foam though a forced air oven, IR oven, microwave oven or radiowave oven. The extent to which a foam is dried depends on the application. In certain embodiments, greater than 50% of the aqueous phase is removed. In certain other embodiments greater than 90%, and in still other embodiments greater than 95% of the aqueous phase is removed during the drying process.

In an embodiment, open-cell foam is produced from the polymerization of the monomers having a continuous oil phase of a High Internal Phase Emulsion (HIPE). The HIPE may have two phases. One phase is a continuous oil phase having monomers that are polymerized to form a HIPE foam and an emulsifier to help stabilize the HIPE. The oil phase may also include one or more photo-initiators. The monomer component may be present in an amount of from about 80% to about 99%, and in certain embodiments from about 85% to about 95% by weight of the oil phase. The emulsifier component, which is soluble in the oil phase and suitable for forming a stable water-in-oil emulsion may be present in the oil phase in an amount of from about 1% to about 20% by weight of the oil phase. The emulsion may be formed at an emulsification temperature of from about 10° C. to about 130° C. and in certain embodiments from about 50° C. to about 100° C.

In general, the monomers will include from about 20% to about 97% by weight of the oil phase at least one substantially water-insoluble monofunctional alkyl acrylate or alkyl methacrylate. For example, monomers of this type may include C₄-C₁₈ alkyl acrylates and C₂-C₁₈ methacrylates, such as ethylhexyl acrylate, butyl acrylate, hexyl acrylate, octyl acrylate, nonyl acrylate, decyl acrylate, isodecyl acrylate, tetradecyl acrylate, benzyl acrylate, nonyl phenyl acrylate, hexyl methacrylate, 2-ethylhexyl methacrylate, octyl methacrylate, nonyl methacrylate, decyl methacrylate, isodecyl methacrylate, dodecyl methacrylate, tetradecyl methacrylate, and octadecyl methacrylate.

The oil phase may also have from about 2% to about 40%, and in certain embodiments from about 10% to about 30%, by weight of the oil phase, a substantially water-insoluble, polyfunctional crosslinking alkyl acrylate or methacrylate. This crosslinking co-monomer, or cross-linker, is added to confer strength and resilience to the resulting HIPE foam. Examples of crosslinking monomers of this type may have monomers containing two or more activated acrylate, methacrylate groups, or combinations thereof. Nonlimiting examples of this group include 1,6-hexanedioldiacrylate, 1,4-butanedioldimethacrylate, trimethylolpropane triacrylate, trimethylolpropane trimethacrylate, 1,12-dodecyldimethacrylate, 1,14-tetradecanedioldimethacrylate, ethylene glycol dimethacrylate, neopentyl glycol diacrylate (2,2-dimethylpropanediol diacrylate), hexanediol acrylate methacrylate, glucose pentaacrylate, sorbitan pentaacrylate, and the like. Other examples of cross-linkers contain a mixture of acrylate and methacrylate moieties, such as ethylene glycol acrylate-methacrylate and neopentyl glycol acrylate-methacrylate. The ratio of methacrylate:acrylate group in the mixed cross-linker may be varied from 50:50 to any other ratio as needed.

Any third substantially water-insoluble co-monomer may be added to the oil phase in weight percentages of from about 0% to about 15% by weight of the oil phase, in certain embodiments from about 2% to about 8%, to modify properties of the HIPE foams. In certain embodiments, “toughening” monomers may be desired which impart toughness to the resulting HIPE foam. These include monomers such as styrene, vinyl chloride, vinylidene chloride, isoprene, and chloroprene. Without being bound by theory, it is believed that such monomers aid in stabilizing the HIPE during polymerization (also known as “curing”) to provide a more homogeneous and better formed HIPE foam which results in better toughness, tensile strength, abrasion resistance, and the like. Monomers may also be added to confer flame retardancy as disclosed in U.S. Pat. No. 6,160,028 (Dyer) issued Dec. 12, 2000. Monomers may be added to confer color, for example vinyl ferrocene, fluorescent properties, radiation resistance, opacity to radiation, for example lead tetraacrylate, to disperse charge, to reflect incident infrared light, to absorb radio waves, to form a wettable surface on the HIPE foam struts, or for any other desired property in a HIPE foam. In some cases, these additional monomers may slow the overall process of conversion of HIPE to HIPE foam, the tradeoff being necessary if the desired property is to be conferred. Thus, such monomers may be used to slow down the polymerization rate of a HIPE. Examples of monomers of this type may have styrene and vinyl chloride.

The oil phase may further contain an emulsifier used for stabilizing the HIPE. Emulsifiers used in a HIPE may include: (a) sorbitan monoesters of branched C₁₆-C₂₄ fatty acids; linear unsaturated C₁₆-C₂₂ fatty acids; and linear saturated C₁₂-C₁₄ fatty acids, such as sorbitan monooleate, sorbitan monomyristate, and sorbitan monoesters, sorbitan monolaurate diglycerol monooleate (DGMO), polyglycerol monoisostearate (PGMIS), and polyglycerol monomyristate (PGMM); (b) polyglycerol monoesters of—branched C₁₆-C₂₄ fatty acids, linear unsaturated C₁₆-C₂₂ fatty acids, or linear saturated C₁₂-C₁₄ fatty acids, such as diglycerol monooleate (for example diglycerol monoesters of C18:1 fatty acids), diglycerol monomyristate, diglycerol monoisostearate, and diglycerol monoesters; (c) diglycerol monoaliphatic ethers of -branched C₁₆-C₂₄ alcohols, linear unsaturated C₁₆-C₂₂ alcohols, and linear saturated C₁₂-C₁₄ alcohols, and mixtures of these emulsifiers. See U.S. Pat. No. 5,287,207 (Dyer et al.), issued Feb. 7, 1995 and U.S. Pat. No. 5,500,451 (Goldman et al.) issued Mar. 19, 1996. Another emulsifier that may be used is polyglycerol succinate (PGS), which is formed from an alkyl succinate, glycerol, and triglycerol.

Such emulsifiers, and combinations thereof, may be added to the oil phase so that they may have between about 1% and about 20%, in certain embodiments from about 2% to about 15%, and in certain other embodiments from about 3% to about 12% by weight of the oil phase. In certain embodiments, co-emulsifiers may also be used to provide additional control of cell size, cell size distribution, and emulsion stability, particularly at higher temperatures, for example greater than about 65° C. Examples of co-emulsifiers include phosphatidyl cholines and phosphatidyl choline-containing compositions, aliphatic betaines, long chain C₁₂-C₂₂ dialiphatic quaternary ammonium salts, short chain C₁-C₄ dialiphatic quaternary ammonium salts, long chain C₁₂-C₂₂ dialkoyl(alkenoyl)-2-hydroxyethyl, short chain C₁-C₄ dialiphatic quaternary ammonium salts, long chain C₁₂-C₂₂ dialiphatic imidazolinium quaternary ammonium salts, short chain C₁-C₄ dialiphatic imidazolinium quaternary ammonium salts, long chain C₁₂-C₂₂ monoaliphatic benzyl quaternary ammonium salts, long chain C₁₂-C₂₂ dialkoyl(alkenoyl)-2-aminoethyl, short chain C₁-C₄ monoaliphatic benzyl quaternary ammonium salts, short chain C₁-C₄ monohydroxyaliphatic quaternary ammonium salts. In certain embodiments, ditallow dimethyl ammonium methyl sulfate (DTDMAMS) may be used as a co-emulsifier.

The oil phase may comprise a photo-initiator at between about 0.05% and about 10%, and in certain embodiments between about 0.2% and about 10% by weight of the oil phase. Lower amounts of photo-initiator allow light to better penetrate the HIPE foam, which may provide for polymerization deeper into the HIPE foam. However, if polymerization is done in an oxygen-containing environment, there should be enough photo-initiator to initiate the polymerization and overcome oxygen inhibition. Photo-initiators may respond rapidly and efficiently to a light source with the production of radicals, cations, and other species that are capable of initiating a polymerization reaction. The photo-initiators used in the present invention may absorb UV light at wavelengths of about 200 nanometers (nm) to about 800 nm, in certain embodiments about 200 nm to about 350 nm. If the photo-initiator is in the oil phase, suitable types of oil-soluble photo-initiators include benzyl ketals, a-hydroxyalkyl phenones, α-amino alkyl phenones, and acylphospine oxides. Examples of photo-initiators include 2,4,6-[trimethylbenzoyldiphosphine] oxide in combination with 2-hydroxy-2-methyl-1-phenylpropan-1-one (50:50 blend of the two is sold by Ciba Speciality Chemicals, Ludwigshafen, Germany as DAROCUR® 4265); benzyl dimethyl ketal (sold by Ciba Geigy as IRGACURE 651); α-,α-dimethoxy-α-hydroxy acetophenone (sold by Ciba Speciality Chemicals as DAROCUR® 1173); 2-methyl-1-[4-(methyl thio) phenyl]-2-morpholino-propan-1-one (sold by Ciba Speciality Chemicals as IRGACURE® 907); 1-hydroxycyclohexyl-phenyl ketone (sold by Ciba Speciality Chemicals as IRGACURE® 184); bis(2,4,6-trimethylbenzoyl)-phenylphosphineoxide (sold by Ciba Speciality Chemicals as IRGACURE 819); diethoxyacetophenone, and 4-(2-hydroxyethoxy)phenyl-(2-hydroxy-2-methylpropyl) ketone (sold by Ciba Speciality Chemicals as IRGACURE® 2959); and Oligo [2-hydroxy-2-methyl-1-[4-(1-methylvinyl) phenyl]propanone] (sold by Lamberti spa, Gallarate, Italy as ESACURE® KIP EM.

The dispersed aqueous phase of a HIPE may have water, and may also have one or more components, such as initiator, photo-initiator, or electrolyte, wherein in certain embodiments, the one or more components are at least partially water soluble.

One component of the aqueous phase may be a water-soluble electrolyte. The water phase may contain from about 0.2% to about 40%, in certain embodiments from about 2% to about 20%, by weight of the aqueous phase of a water-soluble electrolyte. The electrolyte minimizes the tendency of monomers, co-monomers, and cross-linkers that are primarily oil soluble to also dissolve in the aqueous phase. Examples of electrolytes include chlorides or sulfates of alkaline earth metals such as calcium or magnesium and chlorides or sulfates of alkali earth metals such as sodium. Such electrolyte may include a buffering agent for the control of pH during the polymerization, including such inorganic counter-ions as phosphate, borate, and carbonate, and mixtures thereof. Water soluble monomers may also be used in the aqueous phase, examples being acrylic acid and vinyl acetate.

Another component that may be present in the aqueous phase is a water-soluble free-radical initiator. The initiator may be present at up to about 20 mole percent based on the total moles of polymerizable monomers present in the oil phase. In certain embodiments, the initiator is present in an amount of from about 0.001 to about 10 mole percent based on the total moles of polymerizable monomers in the oil phase. Suitable initiators include ammonium persulfate, sodium persulfate, potassium persulfate, 2,2′-azobis(N,N′-dimethyleneisobutyramidine) dihydrochloride, and other suitable azo initiators. In certain embodiments, to reduce the potential for premature polymerization which may clog the emulsification system, addition of the initiator to the monomer phase may be just after or near the end of emulsification.

Photo-initiators present in the aqueous phase may be at least partially water soluble and may have between about 0.05% and about 10%, and in certain embodiments between about 0.2% and about 10% by weight of the aqueous phase. Lower amounts of photo-initiator allow light to better penetrate the HIPE foam, which may provide for polymerization deeper into the HIPE foam. However, if polymerization is done in an oxygen-containing environment, there should be enough photo-initiator to initiate the polymerization and overcome oxygen inhibition. Photo-initiators may respond rapidly and efficiently to a light source with the production of radicals, cations, and other species that are capable of initiating a polymerization reaction. The photo-initiators used in the present invention may absorb UV light at wavelengths of from about 200 nanometers (nm) to about 800 nm, in certain embodiments from about 200 nm to about 350 nm, and in certain embodiments from about 350 nm to about 450 nm. If the photo-initiator is in the aqueous phase, suitable types of water-soluble photo-initiators include benzophenones, benzils, and thioxanthones. Examples of photo-initiators include 2,2′-Azobis[2-(2-imidazolin-2-yl)propane]dihydrochloride; 2,2′-Azobis( 2-(2-imidazolin-2-yl)propaneldisulfate dehydrate; 2,2′-Azobis (1-imino-1-pyrrolidino-2-ethylpropane) dihydrochloride; 2,2′-Azobis[2-methyl-N-(2-hydroxyethyl)propionamide]; 2,2′-Azobis(2-methylpropionamidine) dihydrochloride; 2,2′-dicarboxymethoxydibenzalacetone, 4,4′-dicarboxymethoxydibenzalacetone, 4,4′-dicarboxymethoxydibenzalcyclohexanone,4-dimethylamino-4′-carboxymethoxydibenzalacetone; and 4,4′-disulphoxymethoxydibenzalacetone. Other suitable photo-initiators that may be used in the present invention are listed in U.S. Pat. No. 4,824,765 (Sperry et al.) issued Apr. 25, 1989.

In addition to the previously described components other components may be included in either the aqueous or oil phase of a HIPE. Examples include antioxidants, for example hindered phenolics, hindered amine light stabilizers; plasticizers, for example dioctyl phthalate, dinonyl sebacate; flame retardants, for example halogenated hydrocarbons, phosphates, borates, inorganic salts such as antimony trioxide or ammonium phosphate or magnesium hydroxide; dyes and pigments; fluorescers; filler pieces, for example starch, titanium dioxide, carbon black, or calcium carbonate; fibers; chain transfer agents; odor absorbers, for example activated carbon particulates; dissolved polymers; dissolved oligomers; and the like.

The absorbent structure produced from the present invention may be used as an absorbent core or a portion of an absorbent core in absorbent articles, such as feminine hygiene articles, for example pads, panty liners, and tampons; wound dressing; disposable diapers; incontinence articles, for example pads, adult diapers; homecare articles, for example wipes, pads, towels; and beauty care articles, for example pads, wipes, and skin care articles, such as used for pore cleaning. The absorbent structure having a topsheet and/or a secondary topsheet integrated into a heterogeneous mass layer having open-cell foam pieces may be used in absorbent articles such as feminine hygiene articles, for example pads, panty liners, and tampons; wound dressings; disposable diapers; incontinence articles, for example pads, adult diapers; homecare articles, for example wipes, pads, towels; and beauty care articles, for example pads, wipes, and skin care articles, such as used for pore cleaning. A diaper may be an absorbent article as disclosed in U.S. patent application Ser. No. 13/428,404, filed on Mar. 23, 2012.

The absorbent core structure may be used as an absorbent core for an absorbent article. In such an embodiment, the absorbent core may be relatively thin, less than about 5 mm in thickness, or less than about 3 mm, or less than about 1 mm in thickness. Cores having a thickness of greater than 5 mm are also contemplated herein. Thickness may be determined by measuring the thickness at the midpoint along the longitudinal centerline of the pad by any means known in the art for doing while under a uniform pressure of 0.25 psi. The absorbent core may comprise absorbent gelling materials (AGM), including AGM fibers, blood gelling agents (e.g. chitosan), quaternary salts or combinations thereof as is known in the art.

The absorbent structure may be formed or cut to a shape, the outer edges of which define a periphery.

In an embodiment, the absorbent structure may be combined with any other type of absorbent layer or non-absorbent layer such as, for example, a layer of cellulose, a layer comprising superabsorbent gelling materials, a layer of absorbent airlaid fibers, a nonwoven layer, or a layer of absorbent foam, or combinations thereof. Other absorbent layers not listed are contemplated herein.

According to an embodiment, an absorbent article may comprise a liquid pervious topsheet. The topsheet suitable for use herein may comprise wovens, non-wovens, apertured webs or not aperture webs, and/or three-dimensional webs of a liquid impermeable polymeric film comprising liquid permeable apertures. The topsheet for use herein may be a single layer or may have a multiplicity of layers. For example, the wearer-facing and contacting surface may be provided by a film material having apertures which are provided to facilitate liquid transport from the wearer facing surface towards the absorbent structure. Such liquid permeable, apertured films are well known in the art. They provide a resilient three-dimensional fibre-like structure. Such films have been disclosed in detail for example in U.S. Pat. No. 3,929,135, 4,151,240, 4,319,868, 4,324,426, 4,343,314, 4,591,523, 4,609,518, 4,629,643, 4,695,422 or WO 96/00548.

The topsheet and/or the secondary topsheet may comprise a nonwoven material. The nonwoven materials of the present invention may be made of any suitable nonwoven materials (“precursor materials”). The nonwoven webs may be made from a single layer, or multiple layers (e.g., two or more layers). If multiple layers are used, they may be comprised of the same type of nonwoven material, or different types of nonwoven materials. In some cases, the precursor materials may be free of any film layers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Values disclosed herein as ends of ranges are not to be understood as being strictly limited to the exact numerical values recited. Instead, unless otherwise specified, each numerical range is intended to mean both the recited values and any integers within the range. For example, a range disclosed as “1 to 10” is intended to mean “1, 2, 3, 4, 5, 6, 7, 8, 9, and 10.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications may be made without departing from the spirit and scope of the invention. It is therefore intended to cover in the appended claims all such changes and modifications that are within the scope of this invention.

What is claimed is:

1. An absorbent foam comprising a first surface and a second surface, wherein the foam comprises one or more etched voids, wherein the one or more etched voids comprise an irregular inner surface.

2. The absorbent foam of claim 1, wherein etched voids are the form of apertures.

3. The absorbent foam of claim 1, wherein the etched voids are in the form of slots.

4. The absorbent foam of claim 1, wherein the absorbent foam is an open cell foam.

5. The absorbent foam of claim 1, wherein the open cell foam is a high internal phase emulsion foam.

6. The absorbent foam of claim 1, wherein the etched voids allow for bending in one of the machine direction, the cross direction, or along a vertical axis.

7. The absorbent foam of claim 1, wherein the absorbent foam comprises of a first absorbent layer and a second absorbent layer.

8. The absorbent foam of claim 7, wherein the first absorbent layer and the second absorbent layer comprise of the same material.

9. The absorbent foam of claim 1, wherein the absorbent foam is an absorbent core for an absorbent article.

10. An absorbent foam comprising a first surface and a second surface, wherein the foam comprises one or more etched voids, wherein the one or more etched voids comprises a first surface diameter and a second surface diameter, wherein the first surface diameter is greater than the second surface diameter.

11. The absorbent foam of claim 10, wherein etched voids are the form of apertures.

12. The absorbent foam of claim 10, wherein the absorbent foam is an open cell foam.

13. The absorbent foam of claim 10, wherein the open cell foam is a high internal phase emulsion foam.

14. The absorbent foam of claim 10, wherein the etched voids allow for bending in one of the machine direction, the cross direction, or along a vertical axis.

15. The absorbent foam of claim 10, wherein the absorbent foam comprises of a first absorbent layer and a second absorbent layer.

16. The absorbent foam of claim 15, wherein the first absorbent layer and the second absorbent layer comprise of the same material.

17. The absorbent foam of claim 10, wherein the absorbent foam is an absorbent core for an absorbent article.

18. An absorbent foam comprising a first surface and a second surface, wherein the foam comprises one or more etched voids, wherein the one or more etched voids comprise an irregular inner surface and wherein the one or more etched voids comprises a first surface diameter and a second surface diameter, wherein the first surface diameter is greater than the second surface diameter.

19. The absorbent foam of claim 18, wherein the open cell foam is a high internal phase emulsion foam.

20. The absorbent foam of claim 18, wherein the absorbent foam is an absorbent core for an absorbent article.
